(19) United States
(12) Patent Application Publication
(10) Pub. No.: US 2004/0037384 A1
(43) Pub. Date: Feb. 26, 2004

(54) Nuclear fusion

(76) Inventor: Oren Scotten, NYC, NY (US)

Correspondence Address: OREN SCOTTEN, APT #602, 171 LEXINGTON Ave., NEW YORK, NY, 10016-6853, US

(21) Appl. No.: 10/165,361

(22) Filed: Aug. 26, 2002

(51) Int. Cl. G21J 1/00; G21B 1/00

(52) U.S. Cl. 376/100

(57) ABSTRACT

My controlled nuclear fusion process is that when two Deuterium atoms are directed through two valves into an area an inch away from the valves to where solar energy coming from the two eight inch diameter parabolic mirrors combine producing a temperature of 27,000,000 degrees F. or more, the electrons then leave the atoms and the remaining Deuterium ions then bump into one another and fuse producing small bits of energy Some remain where the fusion occurs, while others go off in different directions. Some immediately are absorbed by the water in the 6′ cube. Other pieces are absorbed further away, as far as 2½ feet before being absorbed by water.

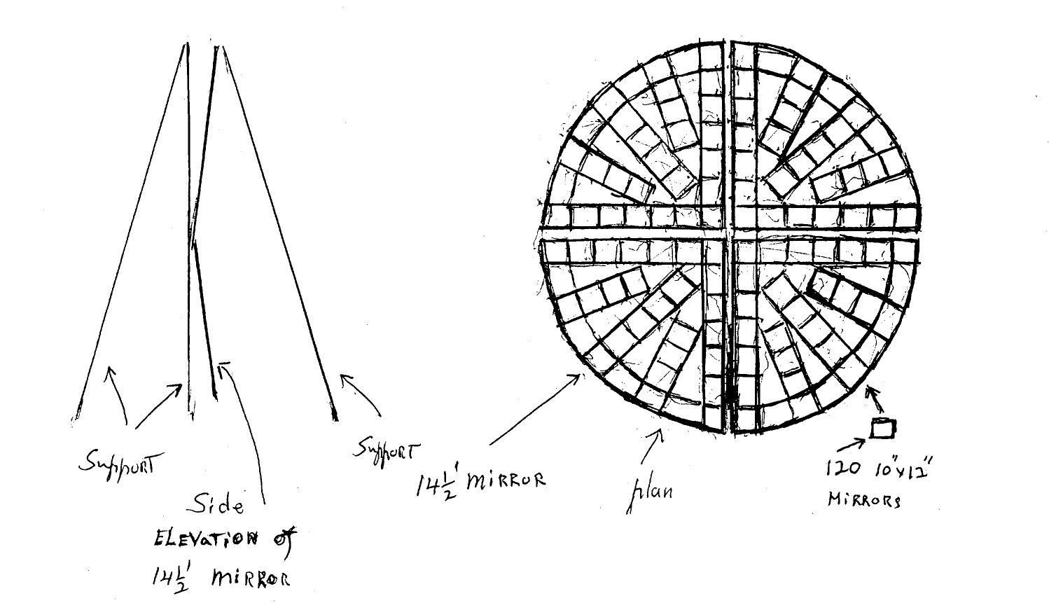

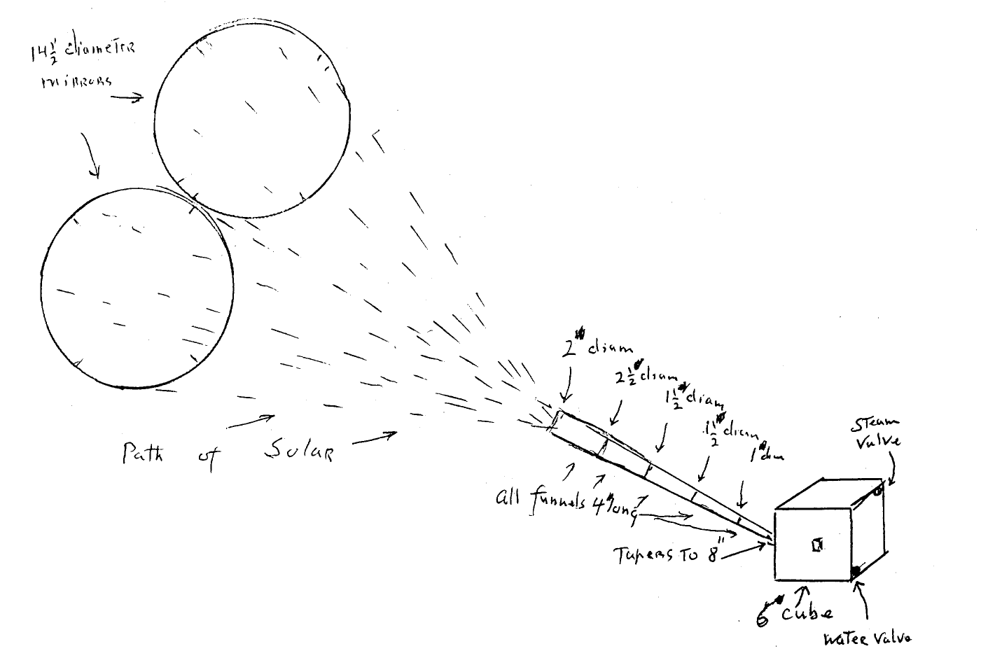

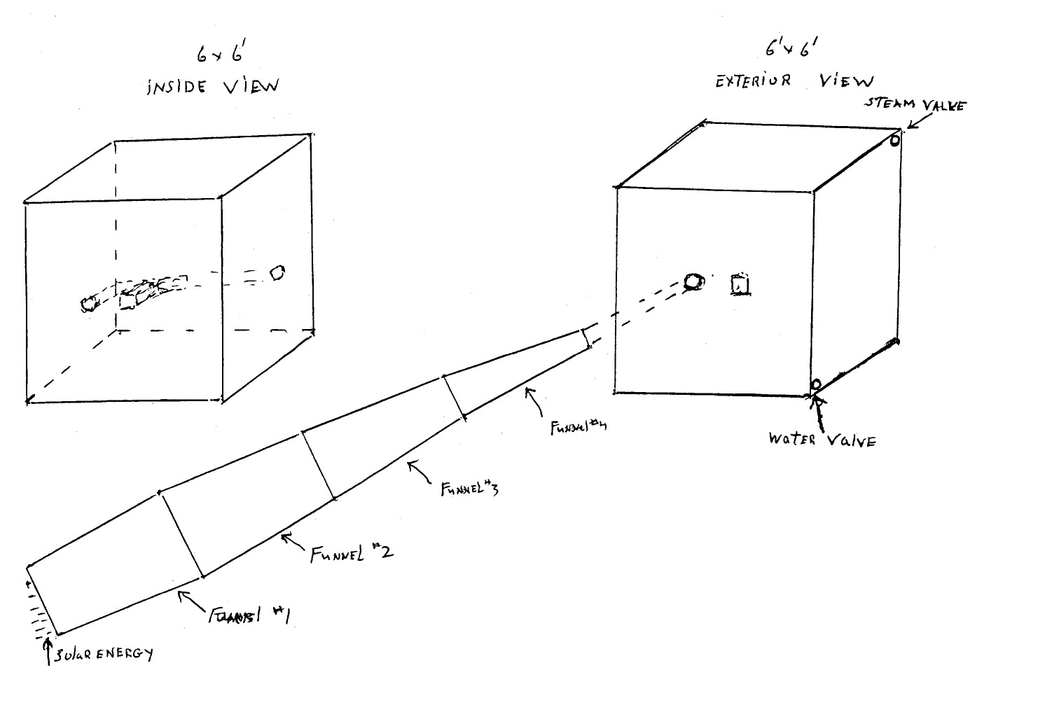

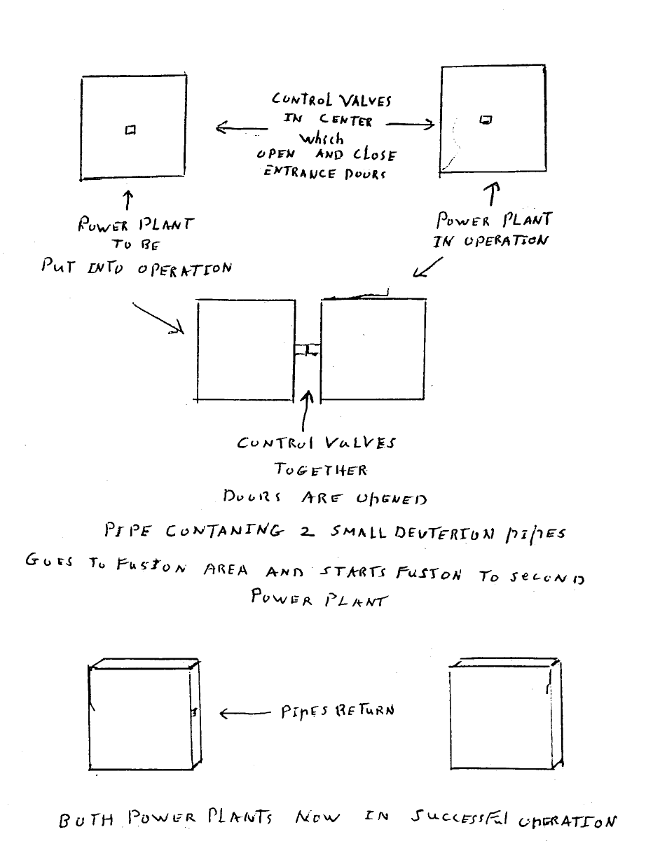

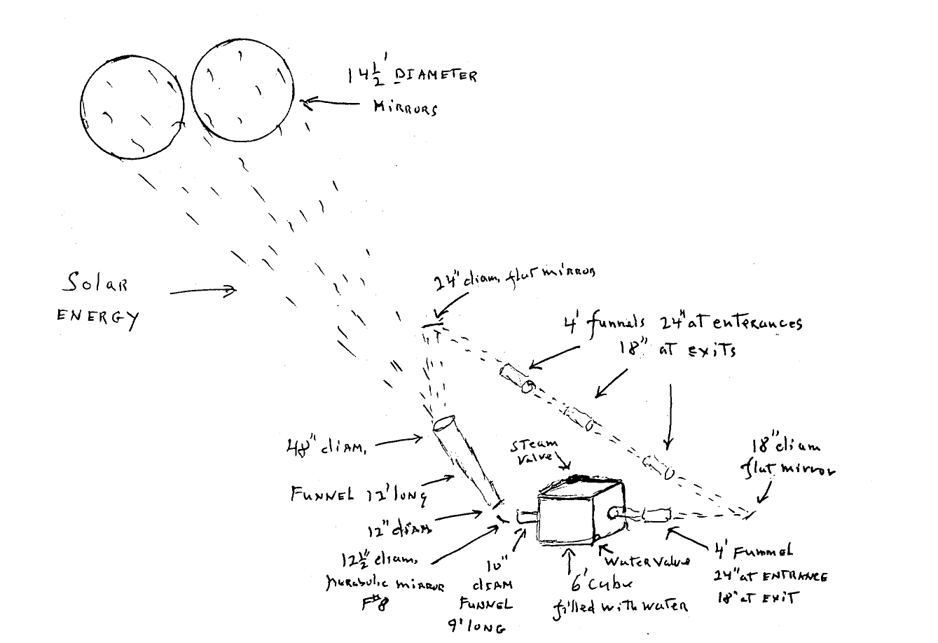

I have water as far as 3′ from the fusion area as a safety precaution.

The supply of Deuterium can be kept just enough to keep the fusion process going when the solar energy is turned off, or kept high for steam production.

My disclosure claims make it possible for Deuterium to compete with the following, coal, oil, natural gas, solar energy, and wind power.

The heat which makes it possible for Deuterium Ions. Which fuse together, and create energy. Obtained from two {2} fourteen and one half {14½} diameter circle, containing, 120 11×12 inch mirrors.

The mirrors collect the solar energy from the sun, then directs it to an aluminum funnel. The funnel is [2] two feet in diameter, expanding to [2½] two and one half feet, with a length of [4] feet.

The second funnel starts at [2½] feet. Then tapers to [2] feet in diameter. It is [4] feet long.

The third funnel starts at [2] feet in diameter, then tapers to [1½] feet in diameter. It is [4] feet long

The fourth funnel starts at [1½] feet in diameter, then tapers to [1] foot in diameter. It is [4] feet long.

The fifth funnel starts at [1′] in diameter, then tapers to [8] inches in diameter. It is four feet long.

Both the fourth and fifth funnels will each be lined with gold leaf.

The fifth funnel which collects the solar energy, is then directed to an [8] inch piece of tempered glass. Then is directed to a tube with dimension of [8½]×[8½] inches square, [3] feet in length. This [3] foot tube is inside a [6]foot×[6]foot cube, containing water. The walls of the [6] foot cube are made of titanium steel. The steel is [⅛th] of [1″] inch thick.

This tunnel is attached to another tunnel [8½] inches square, and [4½] four and one half feet in length. This will go in at a right angle to the first tunnel.

These tunnels are reinforced with [1½] one and one half inch aluminum angles.

There is an [8″] eight inch diameter, parabolic mirror, “F.3” at both ends of the [4½] four and one half foot glass tube.

After the solar energy, goes through the glass into the [1^{st}] first glass tube which is contained within the [6′] six foot cube filled with water. It goes to the [1^{st}] first [8″] eight inch diameter parabolic mirror. “F.3” which reflects the solar energy into an aluminum funnel, which is [8″] eight inches in diameter at the opening. This funnel is [17½] seventeen and one half inches long then tapers to a [½] one half inch in diameter. This funnel is lined with gold leaf.

The solar energy then goes into another funnel, [½″] in diameter at the opening. To [8″] in diameter at the opposite end. This funnel is also [17½] inches in length.

The solar energy is the reflected by an [8″] diameter parabolic mirror “F.3” back into the funnel it exited, then continues on its way back into the [1^{st}] funnel. Continues onto the [1^{st}] parabolic mirror, which is [8″] in diameter. Then reflected out through the glass opening of the [6′] cube filled with water.

The solar energy then continues from the glass opening back through the [5] funnels it came from. Returning it back to the [14½′] mirrors, which contain [240] 11″ by 12″ mirrors. Which reflects the solar energy out into the atmosphere on its way back to the sun.

As the solar energy goes back and fourth as previously described. The temperature at the midway point between the [2] parabolic mirrors is sufficient for the deuterium which then enters through [2] pipes which shall be less than [1] millimeter in diameter which are opposite each other. This then allows the ions released through the [2] pipes to bump into each other allowing fusion to occur.

Once fusion has started the solar energy from the two [2] fourteen and one half [14½′] diameter mirrors can be then turned off. For a continuous stream of deuterium from each of the pipes supplying the deuterium, will enable the temperature to remain constant for continuous fusion.

If it is desired, the amount of deuterium being used can be kept at a modest idling amount, or at a high enough amount to have the water contained in the [6′] cube to get very warm, the it will start producing what ever amount of steam you desire.

The [6′] cube filled with water can be then transported, when enough deuterium is supplied to keep the fusion process going and the water warm. Then when it is desired to have steam, the supply of deuterium going to the fusion area can be increased.

Controlled nuclear fusion is capable of supplying reasonable priced steam any where desired. Assuming that water is always available.

1. That by controlling the amount of deuterium going to an area sufficiently high for fusion to occur, water surrounding the fusion can be kept warm then heated hot enough to produce steam in sufficient quantity and at a desirable pressure to propel steam turbines to make electricity that is produced to a friendly envirement, that is non-polluting. This process can be used for power plants for the majority of navy ships, which I know will greatly increase their range. It would also be desirable for many other uses for other government projects.

2. How a 6′ cube power plant in a fusion operation, can also have the ability to start other power plants of lessor or greater size into a successful fusion operation. How the power plant #1 that is a 6′ cube filled with water that has fusion occurring in the center area of the 6′ long tube in which the fusion has started to occur in a controlled area by the solar energy going through it, starts the deuterium to become hot enough in the central area for fusion to occur, is now capable of fusion to be started in power plant #2. Which is another 6′ cube filled with water. The following paragraph explains how this can be done.
When fusion has been started in the 6′ cube #1 filled with water, 3′ long tube and 6′ cube #2 which is also filled with water, can be put into the 3′ tube of cube # 1. When the end of the 3′ tube of cube #2 is right at the fusion area of cube #2. Deuterium from the 2 small pipes in the 3′ long section of cube #2 is turned on. Fusion heat from cube #1 now starts fusion to begin when the deuterium of the 2 supply pipes in cube #2 begin supply deuterium. The 3′ section of cube #2 is then withdrawn from cube #2 Then moved to the far wall of cube #2. This places the end of the 3′ section where fusion is occurring right in the central area of cube #2. Thus both of the power plants are now in operation.

3. Detailed process:
Solar energy from two fourteen feet six inch diameter mirrors. Each of which are composed of 110 mirrors measuring 10″×12″ goes from these mirrors to a funnel made of 1/16th thick sheet of aluminum that is 36″ in diameter at the exit.
The solar energy then continues on into another funnel of sheet aluminum that is 36″ in diameter at the entrance to 30″ at the exit 4′ away.
The solar energy then continues on into an adjacent funnel of sheet aluminum 30″ in diameter at the entrance to 20″ at the exit which is 4′ away. The solar energy then goes into another aluminum funnel 6′ away is 20″ in diameter at the entrance to 12½ inches in diameter at the exit 4′ away.
The solar energy then goes to a 12.½″ parabolic mirrors F#8 that directs it to a strong heat resistant piece of glass 10″ in diameter that is 3 feet away.
This 10″ diameter glass is the entrance to a 10″ diameter titanium funnel at the entrance in which there is a complete vacuum.
The titanium funnel is 10″ long. The last 6′ of the funnel are in the central area of a 6′ titanium walled cube filled with water. The 10″ diameter titanium funnel will reduce in size to ¼″ in diameter when it reaches the fusion area. Then it immediately increases in size and is 10″ in diameter when it goes through a strong heat resistant pieces of glass 12″ in diameter that is attached to the central area of the titanium wall of the 6′ cube that is directly across from the wall where the solar energy had entered 6′ away. 3′ after the solar energy goes through the 12″ Diameter piece of glass.
The solar energy goes into a funnel that is 14″ in diameter and 12′ long.
The solar energy that now leaves this funnel is directed by a flat mirror 18″ in diameter to another funnel 18″ in diameter and 30″ long. 3′ from the exit of this funnel is another flat mirror 18″ in diameter which directs the solar energy to the entrance of the 20″ diameter funnel that it had previously past through on its way to the 12½ diameter parabolic mirror.
This makes it possible for the solar energy to continue to go through the fusion area many times. Surrounding the fusion area is a titanium tube 2″ wide and ½″ high
That goes from outside the 6′ cube to a continuous supply of cool water and then continuously back around the fusion area.
This arrangement of claim 3 makes it possible for the fusion area previously described to continuously have neutrons of deuterium hitting each other and then fusing. The tiny bits of energy created by the fusion process go in all directions into the water contained in the 6′ cube.

1. That by controlling the amount of deuterium going to an area sufficiently high for fusion to occur, water surrounding the fusion can be kept warm then heated hot enough to produce steam in sufficient quantity and at a desirable pressure to propel steam turbines to make electricity that is produced to a friendly envirement, that is non-polluting. This process can be used for power plants for the majority of navy ships, which I know will greatly increase their range. It would also be desirable for many other uses for other government projects.

2. How a 6′ cube power plant in a fusion operation, can also have the ability to start other power plants of lessor or greater size into a successful fusion operation.
How the power plant #1 that is a 6′ cube filled with water that has fusion occurring in the center area of the 6′ long tube in which the fusion has started to occur in a controlled area by the solar energy going through it, starts the deuterium to become hot enough in the central area for fusion to occur, is now capable of fusion to be started in power plant #2. Which is another 6′ cube filled with water. The following paragraph explains how this can be done.
When fusion has been started in the 6′ cube #1 filled with water, 3′ long tube and 6′ cube #2 which is also filled with water, can be put into the 3′ tube of cube # 1. When the end of the 3′ tube of cube #2 is right at the fusion area of cube #2. Deuterium from the 2 small pipes in the 3′ long section of cube #2 is turned on. Fusion heat from cube #1 now starts fusion to begin when the deuterium of the 2 supply pipes in cube #2 begin supply deuterium. The 3′ section of cube #2 is then withdrawn from cube #2 Then moved to the far wall of cube #2. This places the end of the 3′ section where fusion is occurring right in the central area of cube #2. Thus both of the power plants are now in operation.

3. Detailed process:
Solar energy from two fourteen feet six inch diameter mirrors. Each of which are composed of 110 mirrors measuring 10″×12″ goes from these mirrors to a funnel made of 1/16th thick sheet of aluminum that is 36″ in diameter at the exit.
The solar energy then continues on into another funnel of sheet aluminum that is 36″ in diameter at the entrance to 30″ at the exit 4′ away.
The solar energy then continues on into an adjacent funnel of sheet aluminum 30″ in diameter at the entrance to 20″ at the exit which is 4′ away. The solar energy then goes into another aluminum funnel 6′ away is 20″ in diameter at the entrance to 12½ inches in diameter at the exit 4′ away.
The solar energy then goes to a 12.½″ parabolic mirrors F#8 that directs it to a strong heat resistant piece of glass 10″ in diameter that is 3 feet away.
This 10″ diameter glass is the entrance to a 10″ diameter titanium funnel at the entrance in which there is a complete vacuum.
The titanium funnel is 10″ long. The last 6′ of the funnel are in the central area of a 6′ titanium walled cube filled with water. The 10″ diameter titanium funnel will reduce in size to ¼″ in diameter when it reaches the fusion area. Then it immediately increases in size and is 10″ in diameter when it goes through a strong heat resistant pieces of glass 12″ in diameter that is attached to the central area of the titanium wall of the 6′ cube that is directly across from the wall where the solar energy had entered 6′ away. 3′ after the solar energy goes through the 12″ Diameter piece of glass.
The solar energy goes into a funnel that is 14″ in diameter and 12′ long.
The solar energy that now leaves this funnel is directed by a flat mirror 18″ in diameter to another funnel 18″ in diameter and 30″ long. 3′ from the exit of this funnel is another flat mirror 18″ in diameter which directs the solar energy to the entrance of the 20″ diameter funnel that it had previously past through on its way to the 12½ diameter parabolic mirror.
This makes it possible for the solar energy to continue to go through the fusion area many times. Surrounding the fusion area is a titanium tube 2″ wide and ½″ high
That goes from outside the 6′ cube to a continuous supply of cool water and then continuously back around the fusion area.
This arrangement of claim 3 makes it possible for the fusion area previously described to continuously have neutrons of deuterium hitting each other and then fusing. The tiny bits of energy created by the fusion process go in all directions into the water contained in the 6′ cube.
